(19) United States
(12) Patent Application Publication
(10) Pub. No.: US 2018/0082186 A1
(43) Pub. Date: Mar. 22, 2018

(54) ESTIMATION DEVICE, ESTIMATION METHOD, AND NON-TRANSITORY COMPUTER READABLE STORAGE MEDIUM

(71) Applicant: YAHOO JAPAN CORPORATION, Tokyo (JP)

(72) Inventor: Ikuo KITAGISHI, Tokyo (JP)

(73) Assignee: YAHOO JAPAN CORPORATION, Tokyo (JP)

(21) Appl. No.: 15/694,411

(22) Filed: Sep. 1, 2017

(30) Foreign Application Priority Data
Sep. 20, 2016 (JP) 2016-182650

(51) Int. Cl. G06N 5/02; G06N 7/00

(52) U.S. Cl. CPC G06N 5/02; G06N 7/005

(57) ABSTRACT

According to one aspect of an embodiment an estimation device includes a collecting unit that collects pieces of operation information that indicate operational statuses of electric devices, provided in a predetermined facility, and terminal information that is acquired by a terminal device of a user in the predetermined facility. The estimation device includes an estimating unit that estimates an action of a user in the predetermined facility based on the pieces of operation information and the terminal information.

### CROSS-REFERENCE TO RELATED APPLICATIONS

The present application claims priority to and incorporates by reference the entire contents of Japanese Patent Application No. 2016-182650 filed in Japan on Sep. 20, 2016.

### BACKGROUND OF THE INVENTION

### 1. Field of the Invention

The present invention relates to an estimation device, an estimation method, and a non-transitory computer readable storage medium.

### 2. DESCRIPTION OF THE RELATED ART

There are conventionally-known technologies in which a sensing device is provided in a house and, based on the sensor information from the sensing device, the in-house environment is estimated. For example, there is a known technology to estimate the activity situation of a resident on the basis of the power usage information on the house.
Patent Literature 1: Japanese Laid-open Patent Publication No. 2004-096630.

However, according to the conventional technologies, if there are multiple users in the house, it is sometimes difficult to estimate actions of the users on a per user basis.

### SUMMARY OF THE INVENTION

It is an object of the present invention to at least partially solve the problems in the conventional technology.

According to one aspect of an embodiment an estimation device includes a collecting unit that collects pieces of operation information that indicate operational statuses of electric devices, provided in a predetermined facility, and terminal information that is acquired by a terminal device of a user in the predetermined facility. The estimation device includes an estimating unit that estimates an action of a user in the predetermined facility based on the pieces of operation information and the terminal information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram that illustrates an example of the process that is performed by an information management system according to an embodiment;

FIG. 2 is a diagram that illustrates an example of the functional configuration included in an estimation device according to the embodiment;

FIG. 3 is a diagram that illustrates an example of the information that is registered in a terminal information database according to the embodiment;

FIG. 4 is a diagram that illustrates an example of the information that is registered in an operation information database according to the embodiment;

FIG. 5 is a diagram that illustrates an example of the information that is registered in an estimation information database according to the embodiment;

FIG. 6 is a flowchart that illustrates an example of the flow of an estimation process that is performed by the estimation device according to the embodiment; and

FIG. 7 is a diagram that illustrates an example of the hardware configuration.

### DETAILED DESCRIPTION OF THE PREFERRED EMBODIMENTS

With reference to the drawings, a detailed explanation is given below of aspects (hereafter, referred to as “embodiments”) for implementing the estimation device, the estimation method, and a non-transitory computer readable storage medium according to the subject application. Furthermore, the estimation device, the estimation method, and the non-transitory computer readable storage medium according to the subject application are not limited to the embodiments. Moreover, in each of the following embodiments, the same components are attached with the same reference numeral, and duplicated explanations are omitted.

1-1. An Example of the Estimation Device

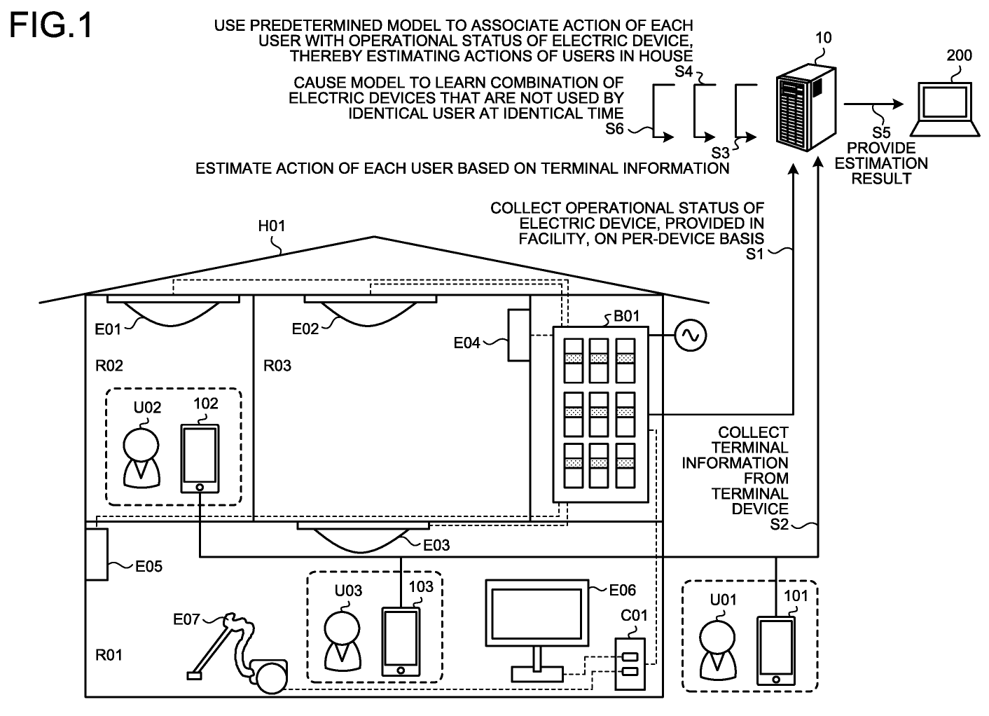

First, by using FIG. 1, an example of an estimation device 10 is explained. FIG. 1 is a diagram that illustrates an example of the process that is performed by an information management system according to the embodiment. As an example of the estimation process that is performed by the estimation device 10, FIG. 1 illustrates an example of the estimation process to estimate the relationship (hereafter, sometimes referred to as “user action”) between the action of a user in a house H01 and the user that has performed the action.

Furthermore, the following explanation describes an example of the process during which the estimation device 10 estimates the user action in the house H01; however, this is not a limitation on the embodiments. For example, the estimation device 10 may estimate the user action in any facilities, such as offices, apartments, buildings, any commercial facilities, or concert halls, as well as the house H01. That is, as it is obvious from the explanations below, the estimation device 10 is capable of estimating the user action in any facility if an electric device is provided in the facility.

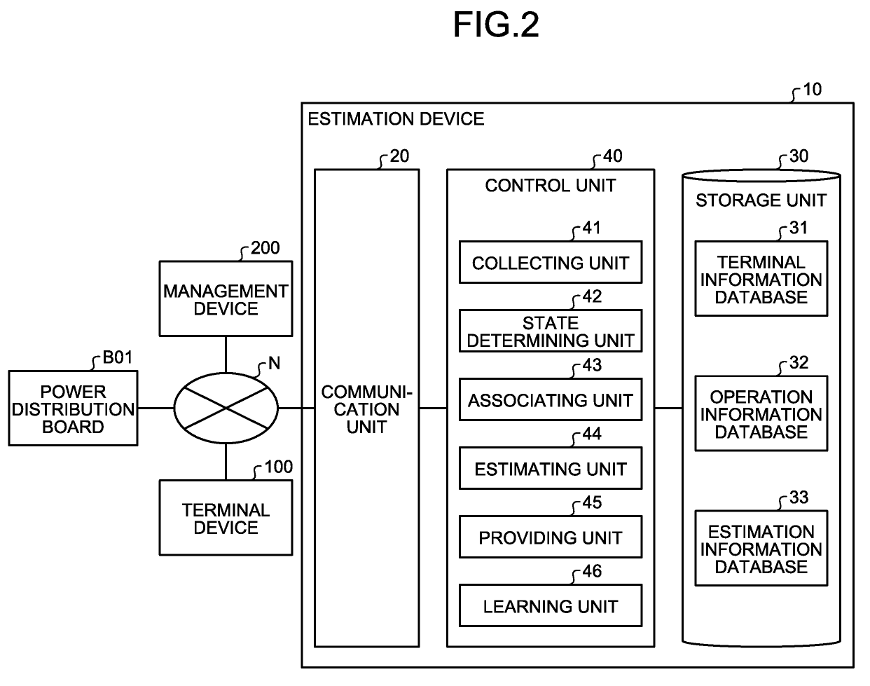

In the example illustrated in FIG. 1, the estimation device 10 is capable of communicating with multiple terminal devices 101 to 103 and a management device 200 via a network N (for example, see FIG. 2), such as the Internet. Furthermore, other than the terminal devices 101 to 103, the estimation device 10 is capable of communicating with any number of terminal devices or management devices.

The terminal devices 101 to 103 are information processing devices that are used by users U01 to U03, and they are terminal devices that are capable of executing any applications. Specific examples are given; the terminal devices 101 to 103 are mobile terminals, such as smartphones, tablet terminals, or Personal Digital Assistant (PDA), desktop personal computers (PCs), notebook PCs, or the like. Furthermore, the terminal device 101 is a terminal device that is used by the user U01, the terminal device 102 is a terminal device that is used by the user U02, and the terminal device 103 is a terminal device that is used by the user U03. Moreover, in the following explanations, the terminal devices 101 to 103 are collectively referred to as a terminal device 100.

Here, the terminal device 100 has various types of sensing functions to detect physical states. For example, the terminal device 100 includes sensors, such as a gyroscope that detects the tilt of the terminal device 100 with respect to the ground; an acceleration sensor that detects the acceleration that acts on the terminal device 100; or a brightness sensor that detects the brightness around the terminal device 100. Furthermore, the terminal device 100 includes a camera that detects or acquires images around the terminal device 100; a microphone that detects sounds (environment sounds) around the terminal device 100; and the function to detect the position of the terminal device 100 by using a positioning system, such as the Global Positioning System (GPS). Furthermore, the terminal device 100 includes a touch panel so that it detects the type of operation that is performed by the user. Furthermore, in the following explanations, the information, such as the above-described tilt, acceleration, brightness, images, sounds, position, or type of operation, which is detected by the terminal device 100 using various types of sensors or detecting technique, is referred to as sensor data. Moreover, other than the above-described sensor data, the terminal device 100 may acquire any sensor data.

The estimation device 10 is an estimation device that estimates the user action during the estimation process that is described later, and it is implemented by, for example, a cloud system, a server device, or a PC. The management device 200 is an information processing device that is used by the administrator that conducts predetermined management, and it is implemented by, for example, a cloud system, a server device, or a PC. For example, the management device 200 acquires the details of the user action that is estimated by the estimation device 10 during the estimation process that is described later.

The house H01 is a house where the users U01 to U03 live. For example, in the example illustrated in FIG. 1, the house H01 is provided with multiple rooms R01 to R03. Furthermore, the house H01 is provided with a power distribution board B01 that supplies the electric power to various electric devices that are installed in the rooms R01 to R03. For example, the power distribution board B01 distributes the commercial power, supplied from outside, to each of the rooms R01 to R03 so as to feed the electric power to an electric device in the distributed destination.

For example, in the example illustrated in FIG. 1, the power distribution board B01 supplies the electric power via an individual power transmission path to an electric device E01, which is a lighting device that is provided in the room R02, an electric device E02, which is a lighting device that is provided in the room R03, an electric device E03, which is a lighting device that is provided in the room R01, an electric device E04, which is an air-conditioning device that is provided in the room R03, and an electric device E05, which is an air-conditioning device that is provided in the room R01. Furthermore, the power distribution board B01 supplies the electric power to an outlet C01 that is provided in the room R01. The outlet C01 is connected to an electric device E06, which is a television, and an electric device E07, which is a cleaner, and it supplies the electric power, fed from the power distribution board B01, to the electric device E06 and the electric device E07. Moreover, other than the electric devices E01 to E07 that are illustrated in FIG. 1, any electric devices, such as refrigerators or electromagnetic cookers, may be provided in the house H01.

Here, the electric devices E01 to E05 are compatible with an in-house energy monitoring system, what is called Home Energy Management System (HEMS), and they are capable of collecting operational statuses. For example, the electric devices E01 to E03 may notify the power distribution board B01 of the operational statuses as to whether they are lighted up, what the color temperature is for lighting, what the illuminance is for lighting, or the like. Furthermore, the electric devices E04, E05 may notify the power distribution board B01 of the operational statuses as to whether they are in operation, what the set temperature is, whether dehumidification, cooling, or heating is being conducted, what the room temperature is, or the like.

When various types of operation information are received from the electric devices E01 to E05, the power distribution board B01 transmits the received pieces of operation information to the estimation device 10. Furthermore, the power distribution board B01 may transmit the operation information to the management server of HEMS. In such a case, the estimation device 10 may collect the operation information from the management server. Furthermore, a home gateway device in HEMS may collect the operation information on each of the electric devices E01 to E05 and transmit it to the management server or the estimation device 10.

Furthermore, the power distribution board B01 has a function to estimate the operational statuses of the electric devices E06, E07, which are not compatible with HEMS, on the basis of the power waveform, or the like, of the supplied electric power. For example, the power distribution board B01 conducts demultiplexing analysis on the current that is supplied to the outlet C01 and, in accordance with an analysis result, determines the operational status that the power of the electric device E06, which is a television, is turned on or the operational status that the electric device E07 is connected and it is in operation, or the like. Then, the power distribution board B01 may transmit the operation information, which indicates the determined operational status, to the estimation device 10 or the management server. Moreover, the power distribution board B01 may determine the operational statuses of the electric devices E01 to E07 within the house H01 in accordance with a result of the demultiplexing analysis on the current that flows through the principal.

Furthermore, the following embodiment describes an example where the power distribution board B01 performs the function as a home gateway device; however, this is not a limitation on the embodiment. For example, the house H01 may be provided with a gateway device separately from the power distribution board B01 so that the power distribution board B01 operates as one of the HEMS devices. In such a case, the operational statuses of the electric devices E06, E07, which are estimated by demultiplexing analysis, or the like, are transmitted to the gateway device. Furthermore, each of the electric devices E01 to E05 transmits the operation information to the gateway device. Then, the gateway device transmits the operation information on each of the electric devices E01 to E07 to the estimation device 10. In this manner, any configuration may be used as the configuration for the estimation device 10 to collect the operational statuses of the electric devices E01 to E07 within the house H01.

1-2. With Regard to the Estimation Process

Furthermore, the estimation device 10 performs the following estimation process. First, the estimation device 10 collects the pieces of operation information that indicate the operational statuses of the electric devices E01 to E07, provided in the house H01, and the pieces of terminal information that are acquired by the terminal devices 100 of the users U01 to U03 in the house H01. Then, the estimation device 10 estimates the action of the user in the house H01 on the basis of the operation information and the terminal information. More specifically, the estimation device 10 estimates the relationship between various types of actions in the house H01 and the user who has performed the action.

For example, the estimation device 10 collects the operation information, which is collected by the power distribution board B01 from each of the electric devices E01 to E05 by using the function related to HEMS. Furthermore, the estimation device 10 collects the pieces of operation information based on the currents that are supplied to the electric devices E06, E07 on a per electric-device basis. A more specific example is given; the estimation device 10 collects the pieces of operation information on the electric devices E06, E07, which are determined by the power distribution board B01 in accordance with results of demultiplexing analysis on the currents.

Furthermore, the estimation device 10 may collect, as the pieces of operation information, the amounts of currents that are supplied to the electric devices E06, E07 from the power distribution board B01. In such a case, the estimation device 10 may conduct demultiplexing analysis on the collected amount of current and, in accordance with a result of demultiplexing analysis, determine the operational status of each of the electric devices E06, E07.

Furthermore, as the terminal information, the estimation device 10 collects the sensor data that is collected by the terminal device 100. For example, the estimation device 10 collects at least any one of the acceleration information, which indicates the acceleration that is measured by the terminal device 100, and the operation information that indicates the type of operation of the terminal device 100. Furthermore, for example, the estimation device 10 collects the acceleration information, which is measured by a sensor in the terminal device 100, and also collects the operations that have been performed on the terminal devices 100 by the users U01 to U03.

The above sensor data is an index to estimate what kinds of actions are taken by the users U01 to U03 who use the terminal devices 100. For example, the acceleration information acquired by the acceleration sensor is an index to estimate the action, such as whether the user is walking or whether the user is moving. Furthermore, the operation acquired by the touch panel, i.e., the operation that is received by the terminal device 100, is an index to estimate the action, such as whether the users U01 to U03 are executing applications, whether they use the terminal devices 100 to browse web contents, or whether they use the terminal devices 100 to play a game. Moreover, for example, the illuminance information acquired by the illuminance sensor is an index to estimate the action, such as whether the user puts the terminal device 100 in the pocket or bag, whether the user puts it out, or whether the user, who carries the terminal device 100, is inside a room or outside a room.

Furthermore, if these pieces of sensor data are combined, the action of the user may be estimated in more detail. For example, if the acceleration sensor does not detect the acceleration and the illuminance sensor detects the typical illuminance inside a room, it is estimated that, for example, the terminal device 100 is left unattended inside the room. Furthermore, if the acceleration sensor detects changes in the acceleration on a regular basis and the illuminance sensor does not detect light, it is estimated that the users U01 to U03 are walking while the terminal devices 100 are still put in a bag or pocket. Furthermore, if the touch panel detects an operation and the acceleration sensor detects changes in the acceleration on a regular basis, it is estimated that the users U01 to U03 are walking while they are operating the terminal devices 100.

Furthermore, for example, if not only the sensor data but also the information on the application being executed by the terminal device 100 are combined, the action of the user may be estimated in more detail. For example, if the terminal device 100 is executing the application to reproduce music contents, it is estimated that the users U01 to U03 are executing the application.

Therefore, as the terminal information, the estimation device 10 acquires various types of information that may be acquired by the terminal device 100, such as various types of sensor data or the information on the application being executed. Then, based on the terminal information, the terminal device 100 determines the actions that are taken by the users U01 to U03, who use the terminal devices 100.

Furthermore, based on the actions of the users U01 to U03, determined from the pieces of terminal information, and the operational statuses of the electric devices E01 to E07, indicated by the pieces of operation information, the estimation device 10 estimates the action of the user in the house H01 and the user who has taken the action. For example, the estimation device 10 associates the operational statuses of the electric devices E01 to E07, indicated by certain pieces of operation information, with the actions of the users that are likely to be the factors that cause the operational statuses. For example, the estimation device 10 combines a Kohonen's self-organizing map and an associative-memory type neural network to previously generate the model that has learnt the relationship between operational statuses of the electric devices E01 to E07 and actions of the users U01 to U03 and, by using the generated model, associates the operational status with the action. Then, on the basis of the operational status and the action that are associated, the estimation device 10 individually estimates each of the actions of the users U01 to U03 in the house H01.

Furthermore, the estimation device 10 may use any model as long as the model associates the operational statuses of the electric devices E01 to E07 with the actions of the users U01 to U03. For example, the estimation device 10 may use any probability generation model other than the above-described model. Furthermore, the estimation device 10 may cluster an operational status and an action by using the model, which has learned through unsupervised learning that clustering is conducted on the operational status and the action and, in accordance with a result of the clustering, associate the operational status with the action.

For example, the estimation device 10 conducts model learning such that the operational status and the action, which are likely to happen in the identical time, are grouped into the same cluster. Then, the estimation device 10 may use the model to cluster the operational status and the action and associate the operational status and the action, which are grouped into the same cluster. A more specific example is given; if the electric device E02 is lighted up, the estimation device 10 may determine the action that is likely to light up the electric device E02 among the actions of the users U01 to U03, thereby estimating the user who has lighted up the electric device E02.

Furthermore, the estimation device 10 may use the model that has learned through supervised learning to associate the operational status and the action that is likely to cause the operational status. For example, the estimation device 10 determines the action of the user U01 on the basis of the sensor data that is acquired by the terminal device 101 when the user U01 lights up the electric device E02. Then, the estimation device 10 may conduct model learning such that the determined action and the operational status that the electric device E02 is lighted up are grouped into the same cluster. That is, the estimation device 10 may conduct model learning such that the combination of the operational status and the action of the user, which causes the operational status, is correct data.

1-3. With Regard to Use of the Positional Information

Furthermore, as the terminal information, the estimation device 10 collects the pieces of positional information that indicate the positions of the terminal devices 100, i.e., the positions of the users U01 to U03 who use the terminal devices 100. Then, on the basis of the pieces of positional information indicated by the pieces of terminal information and the operational statuses of the electric devices E01 to E07, indicated by the pieces of operation information, the estimation device 10 may estimate the action of the user in the house H01 and the user who has taken the action.

For example, if the position that is indicated by the positional information on the terminal device 101 is away from the position of the house H01 by a predetermined distance, it is estimated that the user U01, who uses the terminal device 101, is not in the house. Furthermore, if the positions that are indicated by the pieces of positional information on the terminal devices 102, 103 fall within a predetermined range from the position of the house H01, it is estimated that the users U02, U03, who use the terminal devices 102, 103, are in the house. In this case, the estimation device 10 may eliminate the action of the user U01 from the targets that are associated with the operational statuses of the electric devices E01 to E07 in the house H01 so that only the actions of the users U02, U03 are the targets to be associated.

Furthermore, to improve the estimation accuracy, the estimation device 10 may further collect the terminal information that is acquired by the terminal device 100 outside the house H01 as the terminal information and, on the basis of the terminal information that is acquired by the terminal device 100 outside the house H01 and the operation information, estimate the actions of the users U01 to U03 in the house H01. That is, the estimation device 10 may estimate the actions of the users U01 to U03 in the house H01 in consideration of the actions that have been taken by the users U01 to U03 outside the house H01.

More specifically, the estimation device 10 estimates the action of the user U01 outside the house H01 on the basis of the terminal information that is acquired by the terminal device 101 outside the house H01. Then, the estimation device 10 may estimate the action of the user U01 in the house H01 on the basis of the estimated action and the operation information. That is, the estimation device 10 may estimate the sequence of actions of the user U01 outside the house H01 and inside the house H01 and associate the estimated action with the operational status.

For example, on the basis of the terminal information on the terminal device 101 outside the house H01, the estimation device 10 determines the sequence of actions that the user U01 has walked from the station to the house H01 in a state where the temperature is higher than a predetermined threshold. Furthermore, on the basis of the terminal information on the terminal device 103, the estimation device 10 determines that the user U03 is in the house H01. Here, the operation information indicates that the power of the electric device E04 has been turned on, an operation has been performed to conduct cooling, and the power of the electric device E07 has been turned on.

In this case, compared to the possibility that the user U03 has operated the electric device E04 that is an air-conditioning device, there is a high possibility that the user U01, who has walked home while the temperature is higher than the predetermined threshold, has operated the electric device E04 so as to conduct cooling. Furthermore, there is a low possibility that the user U01 uses the electric device E07, which is a cleaner, as soon as the user comes home, and there is a high possibility that the user U03, who has stayed in the house, uses the electric device E07.

Therefore, the estimation device 10 associates the actions of the users not only in the house H01 but also outside the house H01 with the operational statuses, thereby estimating the users who have operated the electric devices E01 to E07 in the house H01. For example, the estimation device 10 associates the action of the user U01 who has walked from the station to the house H01 in a state where the temperature is higher than the predetermined threshold with the operation information that indicates that the power of the electric device E04 has been turned on and an operation has been performed to conduct cooling. Furthermore, the estimation device 10 associates the action of the user U03 who has continuously stayed in the house H01 with the operational status that indicates that the electric device E07 is being used. As a result, the estimation device 10 estimates the action of the user U01 who has operated the electric device E04 so as to conduct cooling and the action of the user U03 who has used the electric device E07. The above estimation may be achieved by using the model that has learned through supervised learning that if the temperature is high, there is a high possibility that the user, who has stayed outside the house H01, turns on cooling or an associative-memory type neural network.

1-4. With Regard to Learning of the Exclusive Relationship

Furthermore, the estimation device 10 may learn the types of usage of the electric devices E01 to E07 in consideration of the chronological order on the basis of the pieces of operation information on the electric devices E01 to E07 and estimate the actions of the users U01 to U03 in the house H01 on the basis of learning results, the pieces of operation information, and the pieces of terminal information. For example, the estimation device 10 may learn electric devices that are not used at the identical time by the identical user on the basis of the pieces of operation information on the electric devices E01 to E07 and estimate the actions of the users U01 to U03 in the house H01 in accordance with learning results.

For example, if the power sources of the electric device E02, provided in the room R03, and the electric device E06, provided in the room R01, are not operated at the identical time, or if the electric device E03 in the room R01 and the electric device E01 in the room R02 are not operated at the identical time, it is assumed that there is only one user in the house H01. Therefore, the estimation device 10 may cause the model to learn electric devices that are not used by the identical user at the identical time on the basis of the pieces of operation information on the electric devices E01 to E07 and, by using the model, estimate the actions of the users U01 to U03 in the house H01. For example, if the power sources of the electric device E02, provided in the room R03, and the electric device E06, provided in the room R01, are operated at the identical time, the estimation device 10 may conduct learning on the model that associates the action of each user with the operational status on the assumption that multiple users are present in the house H01.

Furthermore, for example, the estimation device 10 may learn electric devices that are used by the identical user at the identical time on the basis of the pieces of operation information on the electric devices E01 to E07 and estimate the actions of the users U01 to U03 in the house H01 in accordance with a learning result. For example, the estimation device 10 may cause the model to learn electric devices that are used by the identical user at the identical time on the basis of the pieces of operation information on the electric devices E01 to E07 and, by using the model, estimate the actions of the users U01 to U03 in the house H01. For example, if the electric device E03 and the electric device E07 have been operated at the identical time and it has been learned that the electric device E03 and the electric device E07 are electric devices that are operated at the identical time, the estimation device 10 may conduct learning on the model that associates the action of each user with the operational status on the assumption that the electric device E03 and the electric device E07 are operated by the identical user.

1-5. With Regard to an Example of a Determination Process

Next, by using FIG. 1, an explanation is given of an example of an information management process that is performed by the estimation device 10. First, the estimation device 10 collects the operational status of the electric device, provided in the facility, on a per-device basis (Step S1). For example, the estimation device 10 collects the operational status of each of the electric devices E01 to E07 in the house H01 via the power distribution board B01 (Step S1). Furthermore, the estimation device 10 collects, from the terminal device 100, various types of sensor data or positional information, measured by the terminal device 100, as the terminal information (Step S2).

Furthermore, the estimation device 10 estimates the action of each of the users U01 to U03 based on the terminal information (Step S3). For example, the estimation device 10 estimates that the user U01 is walking outside the house H01, the user U02 is operating the terminal device 102 without moving in the house H01, and the user U03 moves in the house H01.

Furthermore, the estimation device 10 uses a predetermined model to associate the action of each of the users U01 to U03 with the operational status of the electric device, thereby estimating the actions of the users U01 to U03 in the house H01 (Step S4). For example, if a predetermined time has elapsed after the electric device E01 is lighted up, there is a high possibility that the user U02, who is operating the terminal device 102 without moving in the house H01, has lighted up the electric device E01. Therefore, the estimation device 10 associates the operational status, where the electric device E01 has been lighted up, with the action of the user U02 who is operating the terminal device 102 without moving in the house H01, thereby estimating that the user U02 has lighted up the electric device E01.

In the same manner, if the electric device E07 is being used, there is a high possibility that the user U03, who is moving in the house H01, is using the electric device E07. Therefore, the estimation device 10 associates the operational status, where the electric device E07 is being used, with the action of the user U03 who is moving in the house H01, thereby estimating that the user U03 is using the electric device E07.

Furthermore, if the power of the electric device E04 is turned on after the user U01 moves to the house H01, there is a high possibility that the user U01 has operated the electric device E04, as compared to the users U02, U03 who have stayed in the house H01. Therefore, the estimation device 10 associates the action of the user U01, who have walked to the house H01, with the operational status, where the power of the electric device E04 has been turned on, thereby estimating that the user U01 has turned on the power of the electric device E04.

Furthermore, the estimation device 10 provides the management device 200 with an estimation result (Step S5). This estimation result is applicable to analysis on the action pattern of each of the users U01 to U03, detection of abnormal actions in the house H01 (e.g., intrusion by suspicious persons), or the like.

Furthermore, the estimation device 10 causes the model to learn the combination of electric devices that are not used by the identical user at the identical time on the basis of the collected operational status (Step S6). As a result, the estimation device 10 may improve model association control.

As described above, the estimation device 10 collects the pieces of operation information that indicate the operational statuses of the electric devices E01 to E07, provided in the house H01, and the pieces of terminal information that are acquired by the terminal devices 100 of the users U01 to U03 in the house H01. Then, the estimation device 10 estimates the action of the user in the house H01 on the basis of the operation information and the terminal information. Therefore, the estimation device 10 is capable of estimating who takes what action in the house H01.

### 2. Configuration of the Estimation Device 100

Next, by using FIG. 2, an example of the functional configuration included in the estimation device 10 is explained. FIG. 2 is a diagram that illustrates an example of the functional configuration included in the estimation device according to an embodiment. As illustrated in FIG. 2, the estimation device 10 includes a communication unit 20, a storage unit 30, and a control unit 40.

The communication unit 20 is implemented by, for example, a Network Interface Card (NIC). Furthermore, the communication unit 20 is connected to the network N via wires or wirelessly, and it transmits and receives information to and from the terminal device 100, the management device 200, and the power distribution board B01.

The storage unit 30 is implemented by a semiconductor memory device, such as a random access memory (RAM) or a flash memory, or a storage device, such as a hard disk or an optical disk, and it has recorded therein programs or information for applications, or the like, which are executed within the estimation device 10. Furthermore, the storage unit 30 may be used as a work area when the estimation device 10 executes programs.

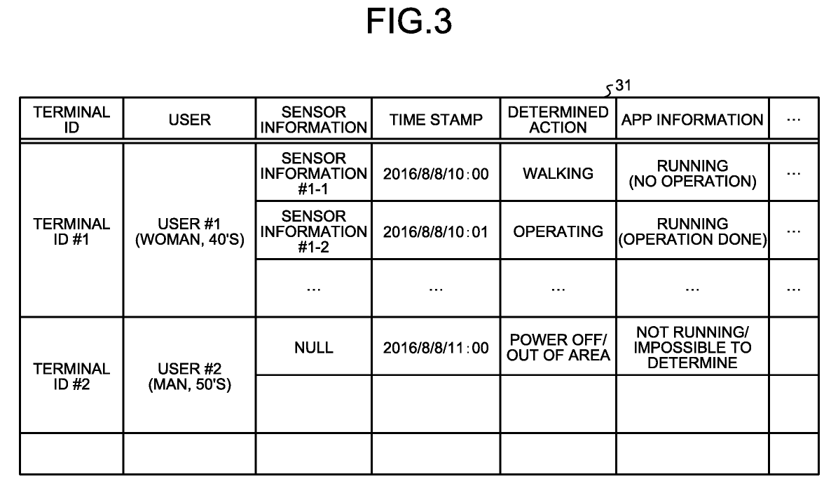

Here, the storage unit 30 includes a terminal information database 31, an operation information database 32, and an estimation information database 33. The terminal information database 31 has registered therein the terminal information that is collected from the terminal device 100, the action of the user that is estimated from the terminal information, or the like. For example, FIG. 3 is a diagram that illustrates an example of the information that is registered in the terminal information database according to the embodiment. As illustrated in FIG. 3, the terminal information database 31 has registered therein the information that includes the items, such as “terminal identifier (ID)”, “user”, “sensor information”, “time stamp”, “determined action”, or “app information”.

Here, “terminal ID” is the identifier for identifying the terminal device 100. “User” is the identifier for identifying the user who uses the terminal device 100 that is indicated by the related “terminal ID”. “Sensor information” is various types of sensor data that is acquired by the terminal device 100 that is indicated by the related “terminal ID”, and it is, for example, the value of acceleration in 3 axial directions, detected by the acceleration sensor. “Time stamp” is the information that indicates the time and date when the related sensor information has been detected. “Determined action” is the information that indicates the action of the user that is estimated from the related sensor information, time stamp, or the like, and it is the information that indicates the action of the user that is estimated from the related sensor information. “App information” is the information that indicates the application being executed by the terminal device 100, indicated by the related “terminal ID”, or whether the user is operating the application.

For instance, in the example illustrated in FIG. 3, the information, such as the terminal ID “terminal ID #1”, the user “user #1 (woman, 40's)”, the sensor information “sensor information #1-1”, the time stamp “2016/8/8/10:00”, the determined action “walking”, the app information “running (no operation)”, is registered. This information indicates that the user, indicated by the user “user #1 (woman, 40's)”, is using the terminal device 100 that is indicated by the terminal ID “terminal ID #1”, and it indicates that the sensor information “sensor information #1-1” has been detected as the sensor data on the time and date that are indicated by the time stamp “2016/8/8/10:00”. Furthermore, this information indicates that the state of the user, estimated from the sensor information “sensor information #1-1”, is “walking”. Furthermore, this information indicates that, when the sensor information “sensor information #1-1” is acquired, a predetermined application is “running” and no operation is performed. Furthermore, in the example illustrated in FIG. 3, the conceptual value, such as “sensor information #1-1”, is described; however, in actuality, various types of sensor data, such as acceleration, positional information, or sounds, is registered.

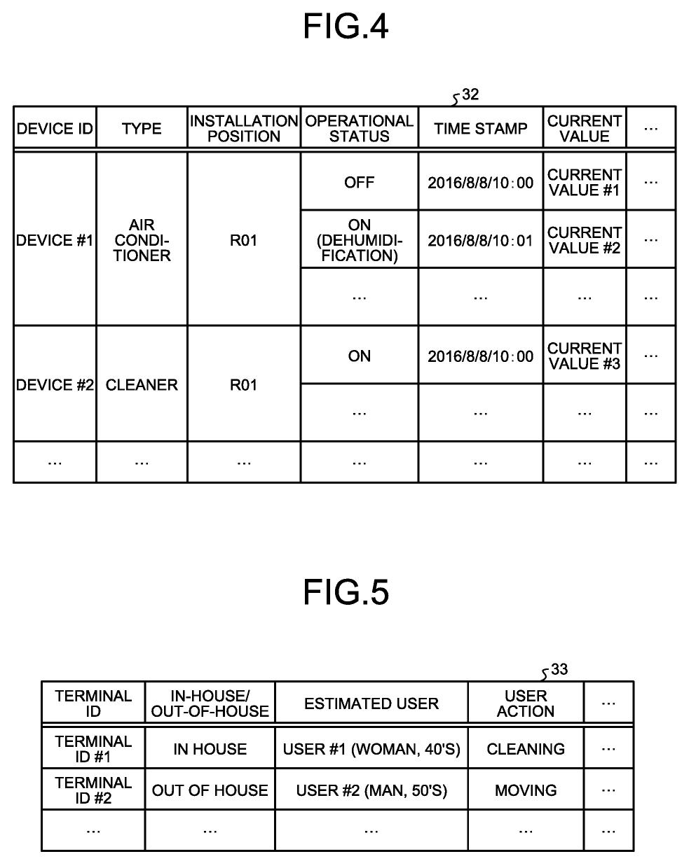

An explanation is continued with reference back to FIG. 2. The operation information database 32 has registered therein the pieces of operation information that indicate the operational statuses of the electric devices E01 to E07. For example, FIG. 4 is a diagram that illustrates an example of the information that is registered in the operation information database according to the embodiment. As illustrated in FIG. 4, the operation information database 32 has registered therein the information that includes the items, such as “device ID”, “type”, “installation position”, “operational status”, “time stamp”, or “current value”.

Here, “device ID” is the identifiers for identifying the electric devices E01 to E07. “Type” is the pieces of information that indicate the types of the electric devices E01 to E07, indicated by the related “device ID”. Furthermore, “installation position” is the pieces of information that indicate the room, or the like, where the electric devices E01 to E07 are installed, indicated by the related “device ID”. Furthermore, “operational status” is the information that indicates the operational status of the device, indicated by the related “device ID”. Furthermore, “current value” is the values of the currents that flow into the electric devices E01 to E07, indicated by the related “device ID”, and it is the information that may be collected as the operation information from the power distribution board B01, or the like.

For instance, in the example illustrated in FIG. 4, the information, such as the device ID “device #1”, the type “air conditioner”, the installation position “R01”, the operational status “OFF”, the time stamp “2016/8/8/10:00”, and the current value “current value #1”, is registered. This information indicates that the type of electric device, indicated by the device ID “device #1”, is “air conditioner” and it is installed in the room “R01”. Furthermore, this information indicates that the electric device, indicated by the device ID “device #1”, is in the state “OFF” on the time and date that are indicated by the time stamp “2016/8/8/10:00” and the current value is “current value #1”. Furthermore, in the example illustrated in FIG. 4, the conceptual value, such as “current value #1” is described; however, in actuality, the amount of current flowing through the electric device is registered.

An explanation is continued with reference back to FIG. 2. The estimation information database 33 has registered therein the operational status and the action of the user that are associated. That is, the estimation information database 33 has registered therein the action of the user in the house H01. For example, FIG. 5 is a diagram that illustrates an example of the information that is registered in the estimation information database according to the embodiment. As illustrated in FIG. 5, the estimation information database 33 has registered therein the information that includes the items, such as “terminal ID”, “in-house/out-of-house”, “estimated user”, and “user action”.

Here, “in-house/out-of-house” is the information that indicates whether the terminal device 100, indicated by the related “terminal ID”, is inside or outside the house H01. Furthermore, “estimated user” is the information that indicates the user who uses the terminal device 100, indicated by the related “terminal ID”. Moreover, “user action” is the estimated action of the user which is performed by the related “estimated user”.

For instance, in the example illustrated in FIG. 5, the estimation information database 33 has registered therein the information, such as the terminal ID “terminal ID #1”, in-house/out-of-house “in house”, the estimated user “user #1 (woman, 40's)”, and the user action “cleaning”. This information indicates that the terminal device 100, indicated by the terminal ID “terminal ID #1”, is “in house” and the estimated user “user #1 (woman, 40's)” is using the terminal device 100 that is indicated by the terminal ID “terminal ID #1”. Furthermore, this information indicates that the estimated user “user #1 (woman, 40's)” is “cleaning”.

An explanation is continued with reference back to FIG. 2. The control unit 40 is a controller, and it is implemented when a processor, such as a central processing unit (CPU) or a micro processing unit (MPU), executes various programs, stored in a storage device inside the estimation device 100, by using a RAM, or the like, as a work area. Furthermore, the control unit 40 is a controller, and it may be implemented by an integrated circuit, such as an application specific integrated circuit (ASIC) or a field programmable gate array (FPGA).

Here, the control unit 40 includes a collecting unit 41, a state determining unit 42, an associating unit 43, an estimating unit 44, a providing unit 45, and a learning unit 46, and it implements or performs information processing functions or operations that are described below.

The collecting unit 41 collects the pieces of operation information that indicate the operational statuses of the electric devices E01 to E07, provided in the house H01, and the pieces of terminal information, acquired by the terminal devices 100 of the users U01 to U03 in the house H01. For example, the collecting unit 41 collects the operational statuses, the types, the installation positions, the time stamps, the current values, or the like, of the electric devices E01 to E05, collected by the power distribution board B01 by using HEMS, as the pieces of operation information. Then, the collecting unit 41 registers the collected operation information in the operation information database 32.

Furthermore, the collecting unit 41 collects the values of the currents that are supplied to the electric devices E06, E07 as the pieces of operation information from the power distribution board B01. In this case, the collecting unit 41 estimates the types, the operational statuses, the time stamps, or the like, of the electric devices E06, E07 from the values of the currents through demultiplexing analysis. Furthermore, the collecting unit 41 estimates the installation positions of the electric devices E06, E07 on the basis of branching by which the power distribution board B01 transmits the currents to the electric devices E06, E07. Then, the collecting unit 41 registers the estimated operational status, type, installation position, or the like, in the operation information database 32. Furthermore, for example, the collecting unit 41 may collect the operation information that indicates the operational status that is estimated by the power distribution board B01.

Furthermore, as the terminal information, the collecting unit 41 collects at least any one of the acceleration information that indicates the acceleration, measured by the terminal device 100, and the operation information that indicates the type of operation of the terminal device 100. Furthermore, as the terminal information, the collecting unit 41 collects the positional information that indicates the position of the terminal device 100. A more specific example is given; the collecting unit 41 collects, from the terminal device 101, the value of the acceleration, detected by using the acceleration sensor, and the position of the terminal device 101, determined by using the GPS, or the like, as the sensor information. Furthermore, the collecting unit 41 collects the time stamp that indicates the time and date on which the sensor information is acquired, the app information that indicates the start-up status or the operating status of an application, or the like. Then, the collecting unit 41 registers the collected terminal information in the terminal information database 31.

Furthermore, the collecting unit 41 collects the terminal information from not only the terminal devices 102, 103 that are used by the users U02, U03, who are inside the house H01, but also the terminal device 101 that is used by the user U01, who is outside the house H01. That is, the estimation device 10 estimates the action of the user in a facility in consideration of the action of the user who is present not only inside the target facility, for which the action of the user is estimated, but also outside the facility.

The state determining unit 42 determines the action of each of the users U01 to U03, who use the terminal devices 100, on the basis of the terminal information that is collected by the collecting unit 41. For example, the state determining unit 42 refers to the terminal information database 31 and, on the basis of the details of the sensing data, indicated by the sensor information, the time and date that are indicated by the time stamp, the start-up status of an application or the presence or absence of an operation, indicated by the app information, or the like, determines what kind of action the user of the terminal device 100, which has detected the sensor information, takes.

For example, if the sensor information indicates that periodic oscillations or acceleration occurs, the state determining unit 42 determines that the user of the terminal device 100, which has detected the sensor information, is “walking”. Furthermore, for example, when the sensor information indicates that oscillations or acceleration does not occur, if the app information indicates that an application has been started up and an operation is being performed, the state determining unit 42 determines that the user of the terminal device 100, which has collected the sensor information, is “operating” the terminal device 100 without moving. Then, the state determining unit 42 registers a determination result as the “determined action”, which indicates the action of the user, in the terminal information database 31.

The associating unit 43 associates the action of the user, indicated by the terminal information, with the operational statuses of the electric devices E01 to E07, indicated by the pieces of operation information. More specifically, the associating unit 43 uses the model, which is generated by the learning unit 46 during the process that is described later, to associate the action of the user, indicated by the terminal information, with the operational statuses of the electric devices E01 to E07, indicated by the pieces of operation information.

For example, the associating unit 43 uses the model, which has conducted learning to determine a certain operational status and the action of the user that is likely to be the factor that causes the operational status, to associate the “operational status”, registered in the operation information database 32, with the action of the user, i.e., “determined action”, registered in the terminal information database 31.

On the basis of the operation information and the terminal information, the estimating unit 44 estimates the actions of the users U01 to U03 in the house H01. More specifically, the estimating unit 44 estimates the actions of the users U01 to U03 in the house H01 on the basis of the actions of the users U01 to U03, indicated by the pieces of terminal information, and the operational statuses of the electric devices E01 to E07, indicated by the pieces of operation information. Furthermore, the estimating unit 44 estimates the action of the user in the house H01 on the basis of the positional information on the terminal device 100, indicated by the terminal information, and the operational statuses of the electric devices E01 to E07, indicated by the pieces of operation information.

A more specific example is given; the estimating unit 44 estimates the action of the user in the house H01 in accordance with an association result of “operational status” and “determined action”, which are associated by the associating unit 43 using the model that is learned by the learning unit 46. For example, the associating unit 43 associates the determined action “walking” of the terminal ID “terminal #1” with the operational status “ON” of the device ID “device #2”. In this case, the estimating unit 44 identifies “user #1 (woman, 40's)”, who uses the terminal device 100 that is indicated by the terminal ID “terminal ID #1”, from the terminal information database 31 and, on the basis of the sensor information that is acquired by the terminal ID “terminal ID #1”, determines whether the terminal device 100, indicated by the terminal ID “terminal ID #1”, is inside or outside the house H01. Then, the estimating unit 44 estimates the action of “user #1” on the basis of the details of “operational status” and the details of “determined action”, which are associated by the associating unit 43. For example, the estimating unit 44 estimates the action of the user such that “user #1” is “cleaning” on the basis of the action that “user #1” is “walking” and the operational status that the type “cleaner” is “ON”. Then, the estimating unit 44 relates the terminal ID “terminal ID #1”, in-house/out-of-house “in-house”, the estimated user “user #1 (woman, 40's)”, and the user action “cleaning”, which is the estimated action of the user, and registers them in the estimation information database 33.

Furthermore, the estimating unit 44 may estimate the action of the user in the house H01 on the basis of the terminal information that is acquired by the terminal device 100 inside the house H01, the terminal information that is acquired by the terminal device 100 outside the house H01, and the operation information. For example, the estimating unit 44 may estimate the action of the user in the house H01 on the basis of the action of the user, which is determined by the state determining unit 42 on the basis of the terminal information that is acquired by the terminal device 100 outside the house H01, and the operation information. For example, if the determined action, which indicates that the user U01 has walked home when the temperature is higher than the predetermined threshold, is associated with the operational status that the electric device E04 has been operated to conduct cooling, the estimating unit 44 may estimate that the user U01 has operated the electric device E04 so as to conduct cooling.

The providing unit 45 provides a predetermined administrator with the actions of the users U01 to U03 in the house H01, which are estimated by the estimating unit 44. For example, the providing unit 45 transmits the pieces of information, registered in the estimation information database 33, to the management device 200. The pieces of information are pieces of information that indicate patterns of the actions of the users U01 to U03 in the house H01. Therefore, the management device 200 extracts the pattern of each of the users U01 to U03 from the received information so as to estimate habits, life styles, or the like, of each of the users U01 to U03. The estimation results may be used for, for example, proposing plans for electric power supply in accordance with habits or life styles, selecting advertisements to be delivered to the terminal device 100 of each of the users U01 to U03, optimizing the timing for delivering advertisements, or the like.

The learning unit 46 conducts learning of the model so as to determine a certain operational status and the action of the user that is likely to be the factor that causes the operational status. For example, the learning unit 46 causes the model to learn the relationship between the operational statuses of the electric devices E01 to E07 and the actions of the users U01 to U03 in combination of the Kohonen's self-organizing map and the associative-memory type neural network.

Here, on the basis of the pieces of operation information on the electric devices E01 to E07, the learning unit 46 causes the model to learn the types of usage of electric devices in consideration of the chronological order. For example, on the basis of the operation information, the learning unit 46 causes the model to learn electric devices that are not used by the identical user at the identical time. For example, the learning unit 46 conducts learning on the model such that the information registered in the estimation information database 33 is clustered as correct data so as to determine electric devices that are not used by the identical user at the identical time, and if the determined electric devices are used, it is estimated that each of the electric devices is used by a different user. Furthermore, on the basis of the operation information, the learning unit 46 may cause the model to learn electric devices that are used by the identical user at the identical time. By using this model, the estimation device 10 may accurately associate the actions of the users with the operational statuses of the electric devices E01 to E07.

### 3. Example of an Information Management Process

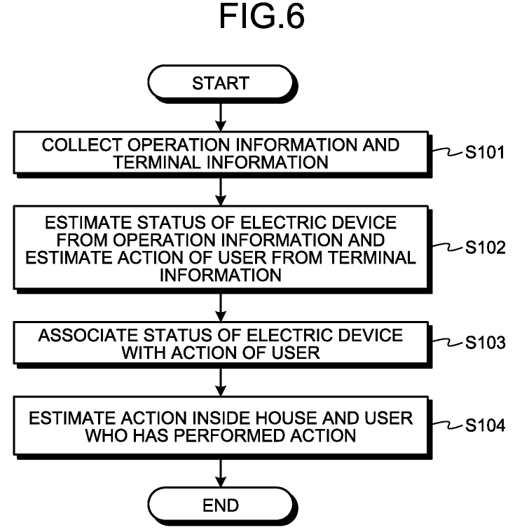

Next, by using FIG. 6, an explanation is given of an example of the flow of an estimation process that is performed by the estimation device 10 according to the embodiment. FIG. 6 is a flowchart that illustrates an example of the flow of the estimation process that is performed by the estimation device according to the embodiment. First, the estimation device 10 collects the operational status and the terminal information (Step S101).

Next, the estimation device 10 estimates the status of the electric device from the operation information and estimates the action of the user from the terminal information (Step S102). Then, the estimation device 10 associates the status of the electric device with the action of the user (Step S103). Specifically, the estimation device 10 associates a certain operational status with the action of the user that is likely to be the factor that causes the operational status. Then, in accordance with an association result, the estimation device 10 estimates the action that is performed inside the house H01 and the user who has performed the action (Step S104) and terminates the process.

### 4. Modified Example

The estimation device 10 according to the above-described embodiment may be implemented in various different embodiments other than the above-described embodiment. Therefore, other embodiments of the above-described estimation device 10 are explained below.

4-1. With Regard to Guests

Here, if there is a guest, or the like, it is expected that unique features occur in the operation information. Therefore, the estimation device 10 may determine the estimated action pattern for each of the users U01 to U03 and, if the operation information different from the determined pattern is detected, output a predetermined notification. For example, the estimation device 10 may make a notification to the terminal devices 100 of the users U01 to U03 to alarm the presence of a suspicious person, notify an inquiry as to whether there is a guest, or the like.

4-2. With Regard to Actions in a Virtual Space

Furthermore, the estimation device 10 may determine the actions of the users U01 to U03 in a virtual space on the basis of operations of the users U01 to U03, sensed by the terminal device 100, and in accordance with an association result of the determined action and the operational status, estimate the actions of the users U01 to U03. For example, if the estimation device 10 receives, from the terminal device 101, the terminal information that an application is performed to check snoring and receives the operation information that the electric device E02 has been turned off, it may estimate the action such that the user U01, who uses the terminal device 101, has turned off the electric device E02 to fall asleep.

4-3. With Regard to the Model

Here, the estimation device 10 may conduct learning on the model, which associates the determined action with the operational status, at any granularity. For example, if there are the houses H01 as the determination targets, the estimation device 10 may conduct learning of the model for each of the houses H01. Furthermore, the estimation device 10 may conduct learning of the model for each facility or conduct learning of the model, which associate the action of the user with the operational status, for example for each family or each user.

4-4. With Regard to the Operation Information

Here, the estimation device 10 may collect the operation information based on the sound information, which is the information related to sounds that are collected by an electric device that is provided in a predetermined facility, for each electric device and estimate the action of the user in the predetermined facility on the basis of the collected operation information. For example, the electric devices include devices that include a means that collects sounds of a microphone, or the like, and that is capable of collecting any sounds, such as voice of a person or environmental sounds in surroundings. The sounds that are collected by the device may be used to, for example, estimate a person by using sound recognition or to estimate the driving state by using sounds (e.g., operation sounds or driving sounds) that are output from other household electrical appliances, or the like.

Therefore, the estimation device 10 collects the operation information based on the sound information, which is the information related to sounds that are collected by an electric device. For example, the estimation device 10 collects it as the drive information that includes sound data on the environmental sounds that are collected by the electric device. In this case, the estimation device 10 analyzes sound data and, by using the technology of sound recognition, or the like, estimates a person who is present around a household electrical appliance. Furthermore, the estimation device 10 analyzes sound data and, on the basis of sounds that are output from a different household electrical appliance, estimates the presence or absence of the different household electrical appliance or the operational status. Then, the estimation device 10 may estimate the action of the user in a predetermined facility on the basis of an estimation result and the terminal information that is collected by the terminal device of each user.

4-5. Others

Furthermore, among the processes described in the above-described embodiments, all or some of the processes that are manually performed as described may be performed automatically by using a known method. Furthermore, operation procedures, specific names, and information including various types of information and parameters as described in the above specifications and the drawings may be optionally changed except as otherwise noted.

Furthermore, the components of each device illustrated are functionally conceptual and do not necessarily need to be physically configured as illustrated in the drawings. Specifically, specific forms of separation and combination of each device are not limited to those depicted in the drawings, and a configuration may be such that all or some of them are functionally or physically separated or combined in an arbitrary unit depending on various types of loads, usage, or the like.

4-6. Hardware Configuration

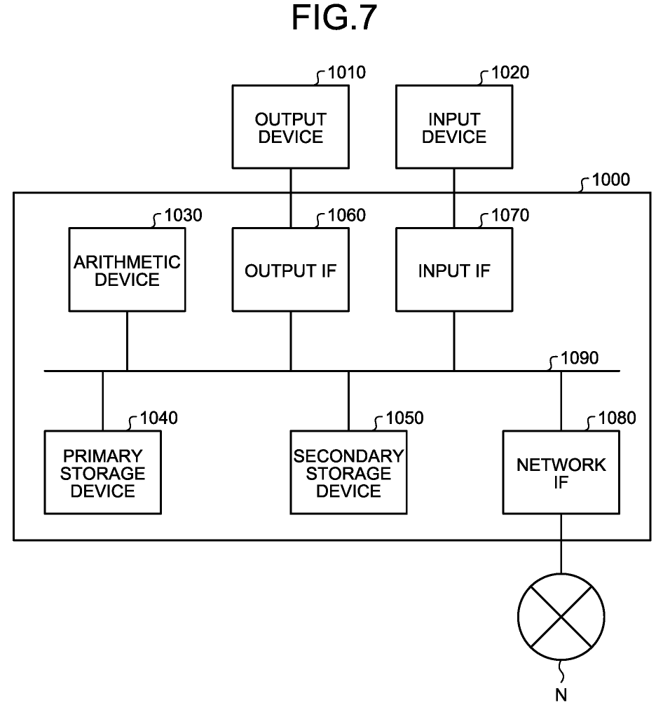

Furthermore, the estimation device 10 according to the above-described embodiment is implemented by a computer 1000 that is configured as illustrated in for example FIG. 7. FIG. 7 is a diagram that illustrates an example of the hardware configuration. The computer 1000 is connected to an output device 1010 and an input device 1020, and it has a configuration such that an arithmetic device 1030, a primary storage device 1040, a secondary storage device 1050, an output interface (IF) 1060, an input IF 1070, and a network IF 1080 are connected via a bus 1090.

The arithmetic device 1030 operates in accordance with programs that are stored in the primary storage device 1040 or the secondary storage device 1050, programs that are read from the input device 1020, or the like, and performs various processes. The primary storage device 1040 is a memory device, such as a RAM, which primarily stores information that is used by the arithmetic device 1030 for various calculations. Furthermore, the secondary storage device 1050 is a storage device that has registered therein information that is used by the arithmetic device 1030 for various calculations or various types of information base, and it is implemented by a read only memory (ROM), a hard disk drive (HDD), a flash memory, or the like.

The output IF 1060 is an interface that transmits information, which is the target to be output, to the output device 1010, such as a monitor or a printer, which outputs various types of information, and it is implemented by a connector that is standardized for, for example, Universal Serial Bus (USB), Digital Visual Interface (DVI), or High Definition Multimedia Interface (HDMI) (registered trademark). Furthermore, the input IF 1070 is an interface that receives information from the various input devices 1020, such as a mouse, a keyboard, or a scanner, and it is implemented by for example a USB.

Furthermore, the input device 1020 may be a device that reads information from an optical recording medium, such as Compact Disc (CD), Digital Versatile Disc (DVD), or Phase change rewritable Disk (PD), a magnetooptical recording medium, such as Magneto-Optical disk (MO), a tape medium, a magnetic recording medium, a semiconductor memory, or the like. Furthermore, the input device 1020 may be an external storage medium, such as a USB memory.

The network IF 1080 receives information from a different device via the network N and transmits it to the arithmetic device 1030, and furthermore it transmits information, generated by the arithmetic device 1030, to a different device via the network N.

The arithmetic device 1030 controls the output device 1010 and the input device 1020 via the output IF 1060 and the input IF 1070. For example, the arithmetic device 1030 loads a program from the input device 1020 or the secondary storage device 1050 into the primary storage device 1040 and executes the loaded program.

For example, if the computer 1000 functions as the estimation device 10, the arithmetic device 1030 in the computer 1000 executes the program, which is loaded into the primary storage device 1040, thereby implementing the function of the control unit 40. Furthermore, the secondary storage device 1050 stores each of the information databases 31 to 33 in the storage unit 30.

### 5. Advantage

As described above, the estimation device 10 collects the pieces of operation information that indicate the operational statuses of the electric devices E01 to E07, provided in a predetermined facility, such as the house H01, and the pieces of terminal information that are acquired by the terminal devices 100 of the users U01 to U03 in the predetermined facility. Then, on the basis of the pieces of operation information and the pieces of terminal information, the estimation device 10 estimates the actions of the users U01 to U03 in the predetermined facility.

As a result, the estimation device 10 may estimate which user takes what kind of action by using the electric devices E01 to E07 in a predetermined facility, such as the house H01; thus, it is possible to estimate activity situations of users in a facility on a per-user basis. Furthermore, the estimation device 10 may estimate what kind of action each user takes without installing a new sensing device in the house H01; thus, it is possible to reduce costs for introducing equipment.

Furthermore, the estimation device 10 collects the pieces of operation information based on the currents that are supplied to the electric devices E01 to E07 for each of the electric devices E01 to E07. Therefore, even if it is difficult to directly collect the pieces of operation information from the electric devices E01 to E07, the estimation device 10 may collect the operational status of each of the electric devices E01 to E07.

Furthermore, as the terminal information, the estimation device 10 collects at least any one of the information that indicates the acceleration, measured by the terminal device 100, and the information that indicates the type of operation of the terminal device 100. Therefore, the estimation device 10 may determine movements, operations, or the like, performed by the users U01 to U03, who use the terminal devices 100.

Furthermore, the estimation device 10 estimates the actions of the users U01 to U03 in a predetermined facility on the basis of the association result of the actions of the users U01 to U03, indicated by the pieces of terminal information, and the operational statuses of the electric devices E01 to E07, indicated by the pieces of operation information. Therefore, the estimation device 10 may correctly estimate the actions of the users U01 to U03 in a predetermined facility.

Furthermore, as the terminal information, the estimation device 10 collects the positional information that indicates the position of the terminal device 100. Then, the estimation device 10 estimates the actions of the users U01 to U03 in a predetermined facility on the basis of the position of the terminal device 100, indicated by the terminal information, and the operational statuses of the electric devices E01 to E07, indicated by the pieces of operation information. Therefore, the estimation device 10 may estimate actions in consideration of whether the users U01 to U03 are inside or outside the house.

Furthermore, the estimation device 10 learns the types of usage of the electric devices E01 to E07 in consideration of the chronological order on the basis of the pieces of operation information on the electric devices E01 to E07. Then, on the basis of the learning result, the operation information, and the terminal information, the estimation device 10 estimates the actions of the users U01 to U03 in a predetermined facility. For example, on the basis of the operation information, the estimation device 10 learns the electric devices E01 to E07 that are not used by the identical users U01 to U03 at the identical time. Then, the estimation device 10 estimates the actions of the users U01 to U03 in the predetermined facility in accordance with a learning result. Furthermore, the estimation device 10 learns the electric devices E01 to E07 that are used by the identical users U01 to U03 at the identical time on the basis of the operation information. Then, the estimation device 10 estimates the actions of the users U01 to U03 in the predetermined facility in accordance with a learning result. As a result of processing, the estimation device 10 may estimate the action of the user in view of the types of usage of the electric devices E01 to E07 in consideration of the chronological order; thus, the estimation accuracy may be improved.

Furthermore, the estimation device 10 further collects the terminal information that is acquired by the terminal device 100 outside a predetermined facility. Then, the estimation device 10 estimates the actions of the users U01 to U03 in the predetermined facility on the basis of the terminal information, acquired by the terminal device 100 outside the predetermined facility, and the operation information. Therefore, the estimation device 10 estimates the actions of the users U01 to U03 in the predetermined facility in consideration of the actions of the users U01 to U03 outside the predetermined facility; thus, the estimation accuracy may be improved.

Moreover, for each electric device, the estimation device 10 collects the operation information based on the sound information that is collected by the electric device. Therefore, the estimation device 10 may estimate the action of the user on the basis of the sounds in a predetermined facility; thus, the estimation accuracy may be further improved.

Furthermore, the above-described “section, module, and unit” may be read as “means”, “circuit”, or the like. For example, the estimating unit may be read as an estimating means or an estimating circuit.

According to an aspect of the embodiment, it is possible to estimate the action of a user in a house on a per-user basis.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An estimation device comprising:
a collecting unit that collects pieces of operation information that indicate operational statuses of electric devices, provided in a predetermined facility, and terminal information that is acquired by a terminal device of a user in the predetermined facility; and
an estimating unit that estimates an action of a user in the predetermined facility based on the pieces of operation information and the terminal information.

2. The estimation device according to claim 1, wherein for each of the electric devices, the collecting unit collects operation information based on a current that is supplied to the electric device.

3. The estimation device according to claim 1, wherein the collecting unit collects, as the terminal information, at least any one of acceleration information, which indicates acceleration that is measured by the terminal device, and operation information that indicates a type of operation of the terminal device.

4. The estimation device according to claim 1, wherein the estimating unit estimates an action of a user in the predetermined facility in accordance with an association result of the action of the user, indicated by the terminal information, and the operational status of the electric device, indicated by the operation information.

5. The estimation device according to claim 1, wherein
the collecting unit collects, as the terminal information, positional information that indicates a position of the terminal device, and
the estimating unit estimates an action of a user in the predetermined facility based on the positional information on the terminal device, indicated by the terminal information, and the operational status of the electric device, indicated by the operation information.

6. The estimation device according to claim 1, comprising a learning unit that learns types of usage of electric devices in consideration of a chronological order based on pieces of operation information on the electric devices, wherein
the estimating unit estimates an action of a user in the predetermined facility based on a learning result by the learning unit, the operation information, and the terminal information.

7. The estimation device according to claim 6, wherein
the learning unit learns electric devices that are not used by an identical user at an identical time based on the pieces of operation information, and
the estimating unit estimates an action of a user in the predetermined facility in accordance with a learning result by the learning unit.

8. The estimation device according to claim 6, wherein
the learning unit learns electric devices that are used by an identical user at an identical time based on the pieces of operation information, and
the estimating unit estimates an action of a user in the predetermined facility in accordance with a learning result by the learning unit.

9. The estimation device according to claim 1, wherein
the collecting unit further collects terminal information that is acquired by the terminal device outside the predetermined facility, and
the estimating unit estimates an action of a user in the predetermined facility based on terminal information, acquired by the terminal device outside the predetermined facility, and the operation information.

10. The estimation device according to claim 1, wherein the collecting unit collects, for each electric device, operation information based on sound information that is collected by the electric device.

11. An estimation method that is implemented by an estimation device, the estimation method comprising:
collecting operation information that indicates an operational status of an electric device, provided in a predetermined facility, and terminal information that is acquired by a terminal device of a user in the predetermined facility; and
estimating an action of a user in the predetermined facility and a user that has performed the action based on the operation information and the terminal information.

12. A non-transitory computer-readable recording medium having stored therein an estimation program that causes a computer to execute a process comprising:
collecting operation information that indicates an operational status of an electric device, provided in a predetermined facility, and terminal information that is acquired by a terminal device of a user in the predetermined facility; and
estimating an action of a user in the predetermined facility and a user that has performed the action based on the operation information and the terminal information.
